(19) United States
(12) Patent Application Publication
(10) Pub. No.: US 2026/0129635 A1
(43) Pub. Date: May 7, 2026

(54) FORWARD ERROR CORRECTION AWARENESS FOR UPLINK

(71) Applicant: QUALCOMM Incorporated, San Diego, CA (US)

(72) Inventors: Hyun Yong LEE, San Diego, CA (US); Diana MAAMARI, San Diego, CA (US); Prashanth Haridas HANDE, San Diego, CA (US); Mickaël MONDET, Louannec (FR); Peerapol TINNAKORNSRISUPHAP, San Diego, CA (US); Sebastian SPEICHER, Wallisellen (CH); Liangping MA, San Diego, CA (US); Huilin XU, Beijing (CN); Linhai HE, San Diego, CA (US); Prasada Veera Reddy KADIRI, San Diego, CA (US)

(21) Appl. No.: 19/374,795

(22) Filed: Oct. 30, 2025

Related U.S. Application Data
(60) Provisional application No. 63/717,736, filed on Nov. 7, 2024.

(51) Int. Cl. H04W 72/115; H04L 1/1607; H04W 72/232

(52) U.S. Cl. CPC H04W 72/115; H04L 1/1614; H04W 72/232

(57) ABSTRACT

Methods, systems, and devices for wireless communications are described. A user equipment (UE) may receive an uplink grant for a resource allocation for a set of data packets and for a set of redundant packets for forward error correction (FEC). The UE may transmit the set of data packets via one or more resources indicated by the resource allocation based on the uplink grant. The UE may receive an indication that the set of data packets have been successfully delivered in response to transmitting the set of data packets. The UE may discard a portion of the set of redundant packets based on the indication that the set of data packets have been successfully delivered. In some examples, the UE may enter a low power mode based on the indication that the set of data packets have been successfully delivered.

### CROSS REFERENCES

The present Application for Patent claims benefit of U.S. Provisional Patent Application No. 63/717,736 by LEE et al., entitled “FORWARD ERROR CORRECTION AWARENESS FOR UPLINK,” filed Nov. 7, 2024, assigned to the assignee hereof, and expressly incorporated by reference herein.

### FIELD OF TECHNOLOGY

The present disclosure relates to wireless communications, including forward error correction awareness for uplink.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an uplink grant for a resource allocation for a set of multiple data packets and for a set of multiple redundant packets for forward error correction (FEC), transmitting the set of multiple data packets via one or more resources indicated by the resource allocation based on the uplink grant, receiving an indication that the set of multiple data packets have been successfully delivered in response to transmitting the set of multiple data packets, and discarding a portion of the set of multiple redundant packets based on the indication that the set of multiple data packets have been successfully delivered.

A UE for wireless communications is described. The UE may include one or more memories storing processor executable code, and one or more processors coupled with the one or more memories. The one or more processors may individually or collectively be operable to execute the code to cause the UE to receive an uplink grant for a resource allocation for a set of multiple data packets and for a set of multiple redundant packets for FEC, transmit the set of multiple data packets via one or more resources indicated by the resource allocation based on the uplink grant, receive an indication that the set of multiple data packets have been successfully delivered in response to transmitting the set of multiple data packets, and discard a portion of the set of multiple redundant packets based on the indication that the set of multiple data packets have been successfully delivered.

Another UE for wireless communications is described. The UE may include means for receiving an uplink grant for a resource allocation for a set of multiple data packets and for a set of multiple redundant packets for FEC, means for transmitting the set of multiple data packets via one or more resources indicated by the resource allocation based on the uplink grant, means for receiving an indication that the set of multiple data packets have been successfully delivered in response to transmitting the set of multiple data packets, and means for discarding a portion of the set of multiple redundant packets based on the indication that the set of multiple data packets have been successfully delivered.

A non-transitory computer-readable medium storing code for wireless communications is described. The code may include instructions executable by one or more processors to receive an uplink grant for a resource allocation for a set of multiple data packets and for a set of multiple redundant packets for FEC, transmit the set of multiple data packets via one or more resources indicated by the resource allocation based on the uplink grant, receive an indication that the set of multiple data packets have been successfully delivered in response to transmitting the set of multiple data packets, and discard a portion of the set of multiple redundant packets based on the indication that the set of multiple data packets have been successfully delivered.

In some examples of the method, UEs, and non-transitory computer-readable medium described herein, receiving the indication that the set of multiple data packets may have been successfully delivered may include operations, features, means, or instructions for receiving downlink control information (DCI) having a format associated with downlink feedback information that indicates the set of multiple data packets may have been successfully delivered.

In some examples of the method, UEs, and non-transitory computer-readable medium described herein, the DCI includes a bitmap that indicates the set of multiple data packets may have been successfully delivered and discarding the portion of the set of multiple redundant packets may be based on the bitmap.

Some examples of the method, UEs, and non-transitory computer-readable medium described herein may further include operations, features, means, or instructions for stopping a retransmission timer in accordance with reception of the DCI.

In some examples of the method, UEs, and non-transitory computer-readable medium described herein, receiving the indication that the set of multiple data packets may have been successfully delivered may include operations, features, means, or instructions for receiving one or more second uplink grants including one or more hybrid automatic repeat request identifiers associated with the set of multiple data packets and a new data indication.

In some examples of the method, UEs, and non-transitory computer-readable medium described herein, each second uplink grant of the one or more second uplink grants includes an indication that second uplink grant may be associated with feedback for the set of multiple data packets and not resource allocation.

In some examples of the method, UEs, and non-transitory computer-readable medium described herein, receiving the one or more second uplink grants may include operations, features, means, or instructions for receiving a second uplink grant for each data packet of the set of multiple data packets that may have been successfully delivered based on transmitting the set of multiple data packets.

In some examples of the method, UEs, and non-transitory computer-readable medium described herein, the portion of the set of multiple redundant packets may be discarded based on a first quantity of the set of multiple data packets being equal to a second quantity of received second uplink grants.

In some examples of the method, UEs, and non-transitory computer-readable medium described herein, receiving the indication that the set of multiple data packets may have been successfully delivered may include operations, features, means, or instructions for receiving a medium access control (MAC) control element (CE) that indicates feedback for the set of multiple data packets.

In some examples of the method, UEs, and non-transitory computer-readable medium described herein, the MAC CE includes a bitmap and each bit of the bitmap indicates hybrid automatic repeat request (HARQ) feedback for a respective data packet of the set of multiple data packets.

In some examples of the method, UEs, and non-transitory computer-readable medium described herein, receiving the indication that the set of multiple data packets may have been successfully delivered may include operations, features, means, or instructions for receiving radio link control (RLC) feedback that indicates feedback for the set of multiple data packets.

Some examples of the method, UEs, and non-transitory computer-readable medium described herein may further include operations, features, means, or instructions for transmitting a request for the RLC feedback associated with a Quality of Service (QoS) flow or a data radio bearer associated with the set of multiple data packets.

Some examples of the method, UEs, and non-transitory computer-readable medium described herein may further include operations, features, means, or instructions for entering a low power mode based on discarding the portion of the set of multiple redundant packets and the indication that the set of multiple data packets may have been successfully delivered.

Some examples of the method, UEs, and non-transitory computer-readable medium described herein may further include operations, features, means, or instructions for transmitting one or more redundant packets via the one or more resources, where the indication that the set of multiple data packets may have been successfully delivered may be based on transmission of the one or more redundant packets of the set of multiple redundant packets.

A method for wireless communications by a network entity is described. The method may include outputting an uplink grant for a resource allocation for a set of multiple data packets and for a set of multiple redundant packets for FEC, obtaining the set of multiple data packets via one or more resources indicated by the resource allocation based on the uplink grant, outputting an indication that the set of multiple data packets have been successfully delivered based on the set of multiple data packets, and refraining from monitoring for a portion of the set of multiple redundant packets based on the indication that the set of multiple data packets have been successfully delivered.

A network entity for wireless communications is described. The network entity may include one or more memories storing processor executable code, and one or more processors coupled with the one or more memories. The one or more processors may individually or collectively be operable to execute the code to cause the network entity to output an uplink grant for a resource allocation for a set of multiple data packets and for a set of multiple redundant packets for FEC, obtain the set of multiple data packets via one or more resources indicated by the resource allocation based on the uplink grant, output an indication that the set of multiple data packets have been successfully delivered based on the set of multiple data packets, and refrain from monitoring for a portion of the set of multiple redundant packets based on the indication that the set of multiple data packets have been successfully delivered.

Another network entity for wireless communications is described. The network entity may include means for outputting an uplink grant for a resource allocation for a set of multiple data packets and for a set of multiple redundant packets for FEC, means for obtaining the set of multiple data packets via one or more resources indicated by the resource allocation based on the uplink grant, means for outputting an indication that the set of multiple data packets have been successfully delivered based on the set of multiple data packets, and means for refraining from monitoring for a portion of the set of multiple redundant packets based on the indication that the set of multiple data packets have been successfully delivered.

A non-transitory computer-readable medium storing code for wireless communications is described. The code may include instructions executable by one or more processors to output an uplink grant for a resource allocation for a set of multiple data packets and for a set of multiple redundant packets for FEC, obtain the set of multiple data packets via one or more resources indicated by the resource allocation based on the uplink grant, output an indication that the set of multiple data packets have been successfully delivered based on the set of multiple data packets, and refrain from monitoring for a portion of the set of multiple redundant packets based on the indication that the set of multiple data packets have been successfully delivered.

In some examples of the method, network entities, and non-transitory computer-readable medium described herein, unsuccessfully decoding at least a first data packet of the set of multiple data packets, obtaining at least one redundant packets of the set of multiple redundant packets via the resource allocation, and repairing at least the first data packet based on the at least one redundant packets, where the indication that the set of multiple data packets may have been successfully delivered may be transmitted based on repairing at least the first data packet.

In some examples of the method, network entities, and non-transitory computer-readable medium described herein, outputting the indication that the set of multiple data packets may have been successfully delivered may include operations, features, means, or instructions for outputting DCI having a format associated with downlink feedback information that indicates the set of multiple data packets may have been successfully delivered.

In some examples of the method, network entities, and non-transitory computer-readable medium described herein, the DCI includes a bitmap that indicates the set of multiple data packets may have been successfully delivered and discarding the portion of the set of multiple redundant packets may be based on the bitmap.

In some examples of the method, network entities, and non-transitory computer-readable medium described herein, outputting the indication that the set of multiple data packets may have been successfully delivered may include operations, features, means, or instructions for outputting one or more second uplink grants including one or more hybrid automatic repeat request identifiers associated with the set of multiple data packets and a new data indication.

In some examples of the method, network entities, and non-transitory computer-readable medium described herein, each second uplink grant of the one or more second uplink grants includes an indication that the second uplink grant may be associated with feedback for the set of multiple data packets and not resource allocation.

In some examples of the method, network entities, and non-transitory computer-readable medium described herein, outputting the one or more second uplink grants may include operations, features, means, or instructions for outputting a second uplink grant for each data packet of the set of multiple data packets that may have been successfully delivered based on a successful decoding of the set of multiple data packets.

In some examples of the method, network entities, and non-transitory computer-readable medium described herein, a first quantity of the set of multiple data packets may be equal to a second quantity of transmitted second uplink grants indicating an acknowledgment.

In some examples of the method, network entities, and non-transitory computer-readable medium described herein, outputting the indication that the set of multiple data packets may have been successfully delivered may include operations, features, means, or instructions for outputting a MAC CE that indicates feedback for the set of multiple data packets.

In some examples of the method, network entities, and non-transitory computer-readable medium described herein, the MAC CE includes a bitmap and each bit of the bitmap indicates HARQ feedback for a respective data packet of the set of multiple data packets.

In some examples of the method, network entities, and non-transitory computer-readable medium described herein, outputting the indication that the set of multiple data packets may have been successfully delivered may include operations, features, means, or instructions for outputting RLC feedback that indicates feedback for the set of multiple data packets.

Some examples of the method, network entities, and non-transitory computer-readable medium described herein may further include operations, features, means, or instructions for obtaining a request for the RLC feedback associated with a QoS flow or a data radio bearer associated with the set of multiple data packets, where outputting the RLC feedback may be based on the request.

Some examples of the method, network entities, and non-transitory computer-readable medium described herein may further include operations, features, means, or instructions for obtaining one or more redundant packets via the resource allocation, where the indication that the set of multiple data packets may have been successfully delivered may be based on the one or more redundant packets of the set of multiple redundant packets.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports forward error correction (FEC) awareness for uplink in accordance with one or more aspects of the present disclosure.

FIG. 2 shows an example of a wireless communications system that supports FEC awareness for uplink in accordance with one or more aspects of the present disclosure.

FIG. 3 shows an example of an uplink feedback technique that supports FEC awareness for uplink in accordance with one or more aspects of the present disclosure.

FIG. 4 shows an example of an uplink feedback technique that supports FEC awareness for uplink in accordance with one or more aspects of the present disclosure.

FIG. 5 shows an example of a process flow that supports FEC awareness for uplink in accordance with one or more aspects of the present disclosure.

FIGS. 6 and 7 show block diagrams of devices that support FEC awareness for uplink in accordance with one or more aspects of the present disclosure.

FIG. 8 shows a block diagram of a communications manager that supports FEC awareness for uplink in accordance with one or more aspects of the present disclosure.

FIG. 9 shows a diagram of a system including a device that supports FEC awareness for uplink in accordance with one or more aspects of the present disclosure.

FIGS. 10 and 11 show block diagrams of devices that support FEC awareness for uplink in accordance with one or more aspects of the present disclosure.

FIG. 12 shows a block diagram of a communications manager that supports FEC awareness for uplink in accordance with one or more aspects of the present disclosure.

FIG. 13 shows a diagram of a system including a device that supports FEC awareness for uplink in accordance with one or more aspects of the present disclosure.

FIGS. 14 through 16 show flowcharts illustrating methods that support FEC awareness for uplink in accordance with one or more aspects of the present disclosure.

### DETAILED DESCRIPTION

Some systems may implement forward error correction (FEC) techniques to reduce latency and improve reliability. For example, an application operating on unlicensed bandwidth, such as an extended reality (XR) or cloud gaming application, may implement FEC. For example, a network node may transmit a set of data packets and a set of redundant packets via a resource allocation. A user equipment (UE) may receive the data packets and use the redundant packets to correct any data packets the UE was unable to correctly decode. The resources to transmit the redundant packets may increase overhead, but correction using the redundant packets may significantly improve latency over retransmission of the improperly decoded data packets. FEC may be implemented for uplink signaling or downlink signaling. In some examples, UE power savings may be improved by implementing FEC awareness techniques. For example, if the UE successfully decodes all transport blocks of a transport block set (e.g., through decoding the transport blocks or by using the redundant packets), the UE may transmit feedback via an uplink to indicate that the transport block set was successfully delivered. The network entity may discard any remaining redundant packets, and the UE may enter a low power mode prior to an end of the resource allocation. Current systems may not support hybrid automatic repeat request (HARQ) feedback for dynamically granted uplink signaling, and therefore may only support FEC awareness for downlink signaling.

A wireless communications system described herein may support techniques for a network entity to provide feedback for a set of data packets to implement FEC awareness for uplink signaling. If the network entity indicates that the set of data packets was successfully delivered, the UE may discard any remaining redundant packets and enter a low power mode. For example, by indicating that the set of data packets has been successfully delivered, the UE may be able to determine that the data packets have been successfully delivered, enabling the UE to discard any non-transmitted redundant data packets used for FEC and enter a low power or sleep mode sooner. In some examples, a network entity may transmit downlink control information (DCI) having a format for downlink feedback information to indicate feedback for the set of data packets. A bitmap in the DCI may indicate whether each data packet of the set of data packets was successfully delivered. In some examples, the network entity may transmit DCI including an uplink grant to indicate the feedback. In some examples, the network entity may transmit a medium access control (MAC) control element (CE) to indicate the feedback or a radio link control (RLC) feedback message to indicate the feedback for the set of data packets.

Aspects of the disclosure are initially described in the context of wireless communications systems. Aspects of the disclosure are further illustrated by and described with reference to apparatus diagrams, system diagrams, and flowcharts that relate to FEC awareness for uplink.

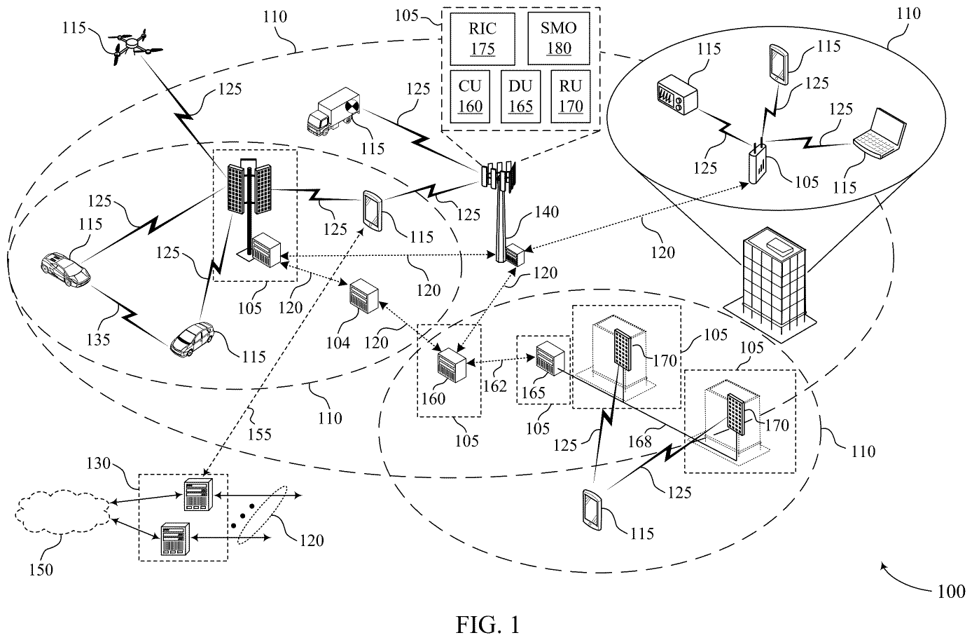

FIG. 1 shows an example of a wireless communications system 100 that supports FEC awareness for uplink in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support FEC awareness for uplink as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), FEC, and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support some communications or applications which require low latency and high reliability. For example, extended reality (XR) and cloud gaming applications may have stringent requirements for latency and reliability. In some examples, these types of applications may implement application-layer FEC. FEC may enable a receiving device to recover or repair source packets without retransmission. By implementing FEC, latency may be reduced, as retransmission may significantly increase latency. With FEC, a transmitting device may be allocated a resource to transmit a set of data packets and one or more redundancy packets, or parity packets, used to repair any data packets that are received with error. Some systems may use a high FEC parity packet ratio to cover a worst-case scenario. For example, including approximately 30% of the set of data packets as redundancy packets (e.g., 10 data packets, 3 redundancy packets) may increase reliability to 99% with the overhead of three additional packets.

The wireless communications system 100 may support FEC awareness for downlink. With FEC awareness for downlink, a UE 115 (e.g., the receiving device) may transmit downlink feedback for a set of data packets received from a network entity 105. If all of the data packets of the set of data packets, or a sufficient quantity of the data packets, have been successfully delivered to the UE 115, the network entity 105 may stop transmission of the redundant packets. This may enable the UE 115 to enter a sleep mode instead of receiving the rest of the redundant packets. For example, the RAN may stop transmission when the UE 115 receives sufficient packets, and the UE 115 may enter a long sleep mode. The network entity 105 may determine the successfully delivered data packets from HARQ or RLC feedback.

In some examples, application layer FEC awareness for downlink may be an example of application layer FEC awareness at an RAN. An application function may send application layer FEC information to the RAN. The application layer FEC information may include, for example, a content ratio for maximum distance separable (MDS) or near-MDS codes. The RAN may determine a quantity of PDUs, or packets, in a PDU set, or a packet set, based on PDU set metadata. For example, a real-time transport protocol (RTP) header extension may indicate the quantity of PDUs in the PDU set. In some examples, the RAN may calculate a required quantity of PDUs from a content ratio and NPDUs, or a quantity of PDUs in a PDU set (e.g., including data packets and redundant packets). The quantity of PDUs may be equal to a ceiling of NPDUs times the content ratio or a floor of NPDUs times the content ratio. For example, if NPDUs is 26 (e.g., including data packets and redundant packets), and the content ratio is 78%, the required quantity of PDUs may be 20.

The wireless communications system 100 may support multiple different formats for DCI. Some DCI may include downlink feedback information (DFI). DFI may be transmitted to a UE 115 and indicate HARQ acknowledgment for each HARQ identifier of a previous uplink shared channel transmission. DCI with a format of 0_1 may carry DFI. A DFI flag may be included to DCI format 0_1 with a cyclic redundancy check scrambled by a configured scheduling radio network temporary identifier (CS-RNTI). If the flag is set to 0, the DCI mya not include DFI. If the flag is set to 1, the DCI may include DFI. DFI may be indicated via a bitmap, where each bit of the bitmap indicates feedback for a HARQ identifier of a previous uplink shared channel transmission. DFI may be used for unlicensed spectrum, where a UE uses DFI to determine a HARQ identifier, redundancy version, and new data indication (NDI) for subsequent configured grant uplink shared channel transmissions. The feedback information may be valid for both previous configured grant uplink shared channel transmissions and previous dynamically granted uplink shared channel transmissions (e.g., scheduled by a DCI). Validity of DFI for an uplink shared channel with a certain HARQ process number may be based on when the uplink shared channel is received with respect to a first symbol of the DCI carrying the DFI.

In some examples, DCI format 0_1 may be used to schedule one or multiple uplink shared channel resources in a cell or to indicate configured grant DFI to a UE 115. DCI format 0_1 may indicate an identifier for the DCI format, a carrier indicator, and a DFI flag. If DCI format 0_1 is used for configured grant DFI, the remaining fields may be used to indicate a HARQ-ACK bitmap and a transmit power control (TPC) command for scheduled uplink shared channel transmissions.

For an uplink shared channel transmission configured by a configured grant, HARQ information for a transport block of a corresponding HARQ process number may be valid if a first symbol of the downlink control channel repetition is after a last symbol of the uplink shared channel transmission, or of any repetition of the PUSCH transmission, by a quantity of symbols provided by a minimum DFI delay for configured grant. For an uplink shared channel transmission scheduled by DCI, HARQ information for a transport block of a corresponding HARQ process number may be valid if a first symbol of the PDCCH repetition is after a last symbol of the uplink shared channel transmission by a quantity of symbols provided by the minimum DFI delay for configured grant. If the uplink shared channel is over multiple slots, the HARQ information may be valid if a first symbol of the downlink control channel repetition is after a last symbol of the uplink shared channel transmission in a first slot of the multiple slots by a quantity of symbols provided by the minimum DFI delay for configured grant if the HARQ information is an ACK. If the uplink shared channel is over multiple slots, the HARQ information may be valid if a first symbol of the downlink control channel repetition is after a last symbol of the uplink shared channel transmission in a first slot of the multiple slots by a quantity of symbols provided by the minimum DFI delay for configured grant if the HARQ information is a NACK.

Some systems may not support explicit HARQ feedback for uplink signaling in licensed bands. For example, these systems may support explicit indication of HARQ acknowledgment (ACK) or negative acknowledgment (NACK) feedback for downlink transmissions (e.g., downlink shared channel transmissions), but these systems may not support explicit indication of HARQ ACK/NACK feedback in licensed bands, such as in commercial 5G or commercial NR systems. For example, some systems may not support a physical HARQ indicator channel (PHICH). Therefore, to confirm the successful delivery of an uplink shared channel transmission, a UE 115 may wait for DCI with a same HARQ identifier and NDI, or the UE 115 may wait for a discontinuous reception (DRX) timer to expire.

As a UE 115 in these systems may wait to determine successful delivery of uplink packets, this introduces latency which reduces performance of application layer FEC techniques for uplink. For example, a UE may be allocated a resource to transmit a set of data packets and a set of redundant data packets via an uplink shared channel. The UE 115 may transmit all of the data packets and begin transmitting the redundant data packets. The UE 115 may not be able to determine whether a sufficient quantity of packets have been successfully delivered, so the UE 115 may continue to transmit the redundant data packets. The UE 115 in these systems may only determine that the sufficient quantity of data packets have been delivered and enter a lower power mode when a DRX retransmission timer expires or the UE 115 receives a DCI with a HARQ identifier corresponding to the set of data packets and an NDI. However, a sufficient quantity of data packets may have been delivered before the UE 115 transmits all of the redundant data packets.

The wireless communications system 100, and wireless communications systems described herein, may support techniques to provide uplink feedback for FEC techniques, enabling FEC awareness for uplink communications. By indicating uplink feedback for a set of data packets, a UE 115 may determine when a sufficient quantity of the data packets have been successfully delivered to a network entity 105, and the UE 115 may enter a lower power state. In some examples, the UE 115 may discard any remaining redundant packets which the UE 115 has not transmitted. In some examples, the network entity 105 may use DFI to indicate uplink feedback for the set of data packets. In some examples, the network entity 105 may transmit a dummy uplink grant, such as an uplink grant which does not allocate any resource blocks, indicating a HARQ identifier that corresponds to a data packet and an NDI. In some examples, the network entity 105 may transmit a MAC CE to indicate uplink feedback for the set of data packets. In some examples, the network entity 105 may transmit RLC ARQ feedback to indicate uplink feedback for the set of data packets.

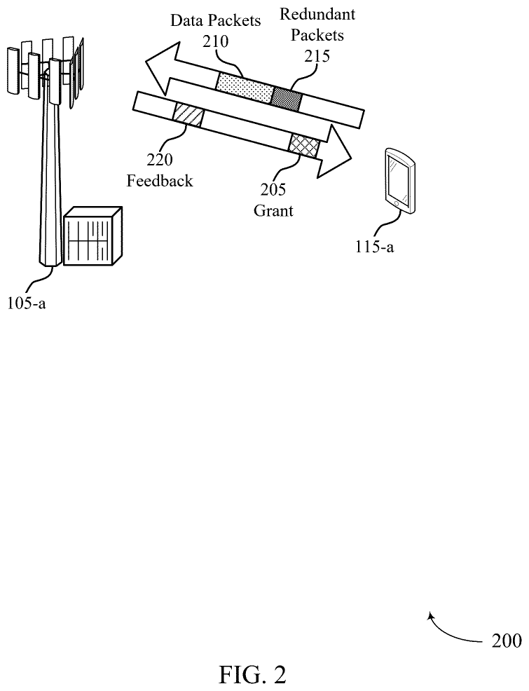

FIG. 2 shows an example of a wireless communications system 200 that supports FEC awareness for uplink in accordance with one or more aspects of the present disclosure. The wireless communications system 200 may include aspects of a wireless communications system 100. For example, the wireless communications system 200 may include a UE 115-a and a network entity 105-a, which may be respective examples of a UE 115 and a network entity 105 described herein.

In some examples, the UE 115-a and the network entity 105-a may communicate via licensed spectrum. For example, the UE 115-a may transmit uplink signaling to the network entity 105-a via a licensed uplink radio frequency spectrum band. The network entity 105-a may transmit downlink signaling to the UE 115-a via a licensed downlink radio frequency spectrum band. In some examples, the UE 115-a and the network entity 105-a may support techniques for FEC, such as application layer FEC, including FEC awareness.

For example, the network entity 105-a may transmit DCI including a grant 205. The grant 205 may allocate one or more uplink resources, such as an uplink shared channel resource, for the UE 115-a to transmit a set of data packets 210 and a set of redundant packets 215 for FEC techniques. The UE 115-a may transmit the set of data packets 210 via the uplink shared channel resource. In some examples, the UE 115-a may begin to transmit the set of redundant packets 215 for FEC techniques.

The UE 115-a and the network entity 105-a may support techniques for FEC awareness for uplink signaling. For example, the network entity 105-a may transmit feedback 220 to the UE 115-a to indicate feedback information for the set of data packets 210. If the feedback 220 indicates that the network entity 105-a has been able to decode a sufficient quantity of data packets (e.g., from the set of data packets 210 or the set of redundant packets 215, or both), the UE 115-a may discard any remaining redundant packets and enter a low power sleep mode. Based on receiving the feedback 220, the UE 115-a may enter a sleep mode earlier than if the UE 115-a were to wait for a retransmission timer expiry.

In some examples, the network entity 105-a may transmit DCI that includes DFI to indicate the feedback 220. For example, PHY layer signaling may reuse DCI Format 0_1 to indicate HARQ feedback for application layer FEC techniques. The network entity 105-a may transmit the DCI including DFI after decoding the physical uplink shared channel transmission (e.g., the set of data packets 210). The UE 115-a may count a quantity of successfully delivered packets (e.g., transport blocks) based on a DFI bitmap. When a sufficient quantity of uplink packets have been delivered, the UE 115-a may discard the remaining packets. When DFI indicates an acknowledgment, the UE 115-a may enter a sleep mode without waiting for a retransmission timer to expire.

In some examples, the network entity 105-a may transmit DCI that includes a dummy grant to indicate the feedback 220. For example, the DCI may include a grant that schedules zero resource blocks, such as a DCI with a grant that indicates a resource block size of zero. The dummy grant may indicate a HARQ identifier of a data packet in the set of data packets 210 and an NDI. A dummy grant may be used to indicate an implicit ACK for an indicated HARQ identifier and may not be used for actual scheduling. The UE 115-a may count the successfully delivered data packets based on a quantity of dummy grants with an NDI the UE 115-a receives.

In some examples, the network entity 105-a may transmit a MAC CE to indicate the feedback 220. The MAC CE may indicate ACK/NACK information for HARQ processes. In some examples, the MAC CE may include a feedback bitmap, where each bit in the bitmap corresponds to a different HARQ process. In some examples, the MAC CE may indicate HARQ identifiers. For example, the MAC CE may include a HARQ identifier to indicate an acknowledgment for the HARQ identifier. Additionally, or alternatively, a first set of HARQ identifiers may be indicated in a first field of the MAC CE to indicate an ACK, and a second set of HARQ identifiers may be indicated in a second field of the MAC CE to indicate a NACK.

In some examples, the network entity 105-a may transmit RLC ARQ feedback to indicate the feedback 220. The UE 115-a may count the successfully delivered packets from the set of data packets 210 based on the RLC ARQ ACK/NACK feedback. When a sufficient quantity of uplink RLC packets are delivered, the UE 115-a may discard the remaining packets. In some examples, the UE 115-a may enter a low power mode or sleep mode after receiving the feedback 220. In some examples, to minimize a delay of RLC feedback, the UE 115-a may transmit a request to the network entity 105-a for fast RLC feedback for a quality of service (QoS) flow or data radio bearer. The request may identify the QoS flow or the data radio bearer. In some examples, a policy control function (PCF) traffic flow template (TFT) may indicate a fast RLC feedback for an identified QoS flow (e.g., from the PCF to the RAN).

In some examples, the network entity 105-a may transmit feedback that is symmetric to downlink feedback. For example, similar to a k1 or slot offset for a downlink shared channel, ACK/NACK feedback timing of an uplink shared channel may be indicated with a DCI that grants the uplink shared channel. The ACK/NACK feedback timing of the uplink shared channel may be indicated by k3, which may be a slot offset from the uplink shared channel to the feedback for the uplink shared channel. HARQ ACK/NACK feedback for a corresponding HARQ identifier may be indicated via DCI in a slot that is k2 (e.g., a timing offset from the DCI that grants the uplink shared channel) plus k3 (e.g., a timing offset from the uplink shared channel to feedback for the uplink shared channel) slots after the DCI that grants the uplink shared channel. Additionally, or alternatively, the HARQ ACK/NACK feedback may be included in PDSCH of the k2+k3 slot. In some examples, the network entity 105-a may transmit a bitmap for 16 HARQ identifiers. The UE 115-a may count successfully delivered data packets based on the HARQ feedback. When a sufficient quantity of uplink packets have been delivered, the UE 115-a may discard the remaining packets. When a PUSCH is indicated as acknowledged, the UE 115-a may enter a sleep mode without waiting for a retransmission timer to expire.

In some examples, the UE 115-a may transmit a buffer status report (BSR) to confirm that a sufficient quantity of packets are delivered. For example, the UE 115-a may receive the feedback 220 that indicates that a sufficient quantity of packets of the set of data packets 210 have been delivered. The UE 115-a may transmit a BSR, indicating that the UE 115-a confirms that the sufficient quantity of packets have been delivered. The UE 115-a may discard the remaining packets and enter a low power sleep mode. Transmitting the BSR may prevent the network entity 105-a from allocating an unnecessary grant for the discarded packets. In some examples, the UE 115-a may transmit the BSR before a BSR prohibit timer expires.

If the network entity 105-a grants the UE 115-a PUSCH resources for the set of redundant packets 215, the UE 115-a may skip the PUSCH transmission if the UE 115-a confirms that a sufficient quantity of data packets have been delivered. For example, the grant 205 or a separate grant may allocate the UE 115-a with resources to transmit the set of redundant packets 215 or additional redundant packets. If the UE 115-a receives the feedback 220 that indicates a sufficient quantity of data packets have been delivered, the UE 115-a may skip transmitting any remaining redundant packets. There may be a delay for uplink shared channel preparation between a DCI grant and the uplink shared channel (e.g., k2). During this delay, the UE 115-a may confirm that the sufficient quantity of packets have been delivered, and the UE 115-a may skip the granted uplink shared channel transmission. The network entity 105-a may configure a dynamic uplink transmission skipping configuration for uplink application layer FEC techniques.

In some examples, the network entity 105-a may transmit uplink HARQ feedback for transport blocks including application layer FEC packets. The PCF TFT may indicate a data radio bearer or QoS flow associated with application layer FEC uplink traffic. The UE 115-a may request uplink HARQ feedback for a data radio bearer or QoS flow. For example, the UE 115-a may transmit uplink assistance information that identifies a data radio bearer or QoS flow and request uplink HARQ feedback.

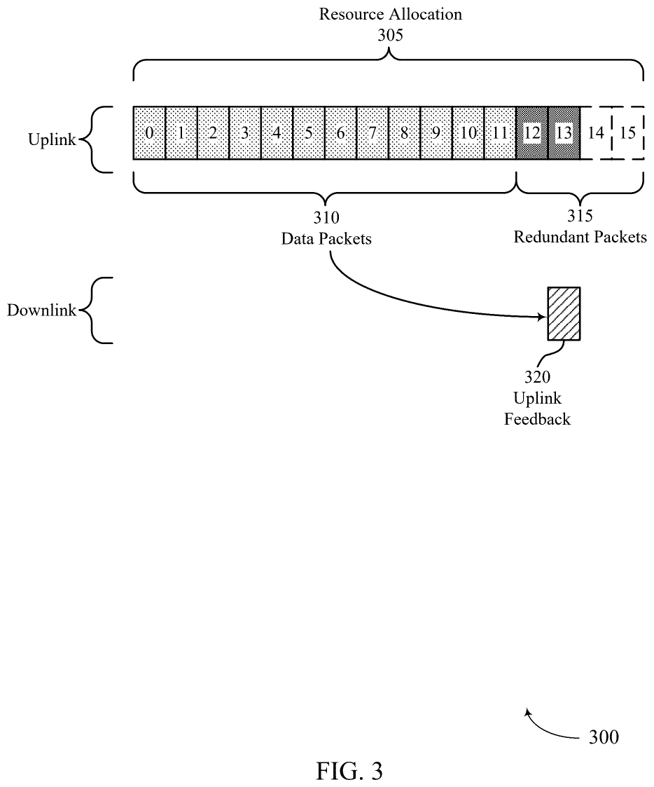

FIG. 3 shows an example of an uplink feedback technique 300 that supports FEC awareness for uplink in accordance with one or more aspects of the present disclosure. The uplink feedback technique may implement some aspects of a wireless communications system 100 or a wireless communications system 200 as described herein. For example, the uplink feedback technique 300 may support uplink feedback for application layer FEC awareness.

A network entity 105 may transmit DCI to grant a resource allocation 305 to a UE 115 for transmission of a set of data packets 310. In some examples, the resource allocation 305 may include resources for the UE 115-a to transmit a set of redundant packets 315 for FEC techniques. For example, if the network entity 105 is unable to decode a data packet, the network entity 105 may use one of the redundant packets to correct decoding errors or repair the data packet.

The network entity 105 may transmit uplink feedback 320 to the UE 115 to indicate HARQ ACK feedback for the set of data packets 310. In the example of the uplink feedback technique 300, the network entity 105 may transmit a single message to indicate the HARQ ACK feedback for the set of data packets 310. If the uplink feedback 320 indicates that a sufficient quantity of data packets have been successfully delivered to the network entity 105, the UE 115 may discard remaining packets (e.g., redundant packets) and enter a low power sleep mode.

For example, the resource allocation 305 may include resources for 16 data packets or transport blocks. The UE 115 may receive the uplink feedback 320 during a transmission time interval for transport block thirteen, corresponding to a redundant packet. The UE 115 may determine that the network entity 105 has received a sufficient quantity of transport blocks, and the UE 115 may discard remaining transport blocks. For example, the UE 115 may discard remaining redundant packets. The UE 115 may enter a low power sleep mode based on receiving the uplink feedback 320 instead of transmitting the last two transport blocks.

In some examples, the uplink feedback 320 may be DCI that includes DFI. PHY layer signaling may use a DCI format associated with DFI to indicate HARQ feedback for uplink FEC awareness techniques. The UE 115 may count the successfully delivered packets based on a DFI bitmap in the uplink feedback 320. In some examples, the UE 115 may memorize a quantity of FEC packets in a transport block and corresponding HARQ identifiers. In some examples, the UE 115 may determine whether the data packets have been successfully delivered or not based on a HARQ-ACK bitmap in the uplink feedback 320. In some examples, the UE 115 may count a quantity of successfully delivered FEC packets. When a sufficient quantity of uplink packets have been delivered, the UE 115 may discard remaining packets. When the DFI indicates an acknowledgment for the set of data packets 310, the UE 115 may enter a sleep mode without waiting for a retransmission timer to expire.

Based on a DFI bitmap in the uplink feedback 320, the UE 115 may be able to determine that a sufficient quantity of packets have been successfully delivered. For example, the UE 115 may determine that twelve packets have been successfully delivered based on the uplink feedback 320 including a bitmap of ‘1111111111110000’. The UE 115 may discard remaining packets, including packet fourteen and packet fifteen.

In some systems, DFI may be used for unlicensed spectrum with a configured grant. The uplink feedback technique 300 may be supported for dynamically grants physical uplink shared channel transmissions on licensed radio frequency spectrum bands. In some examples, DFI for the uplink feedback technique 300 may be configured with a different RNTI than CS-RNTI. In some examples, the network entity 105 may configure the UE 115 with a minimum DFI delay parameter associated with dynamically granted physical uplink shared channel resources.

In some examples, the uplink feedback 320 may be a MAC CE used for uplink application layer FEC awareness. For example, the uplink feedback 320 may be a MAC CE which indicates ACK/NACK information for HARQ processes. In some examples, the MAC CE may include an ACK/NACK bitmap for multiple HARQ processes. In some examples, the MAC CE may include a list of HARQ identifiers associated with an ACK, or a list of HARQ identifiers associated with a NACK, or both. The network entity 105 may deliver or transmit the MAC CE command when the network entity 105 decodes the uplink shared channel transmission. For example, the network entity 105 may decode the set of data packets 310 and transmit the uplink feedback 320 based on successfully decoding the set of data packets 310. When the uplink shared channel is indicated as an ACK by the MAC CE, the UE 115 may discard the remaining packets and enter a sleep mode.

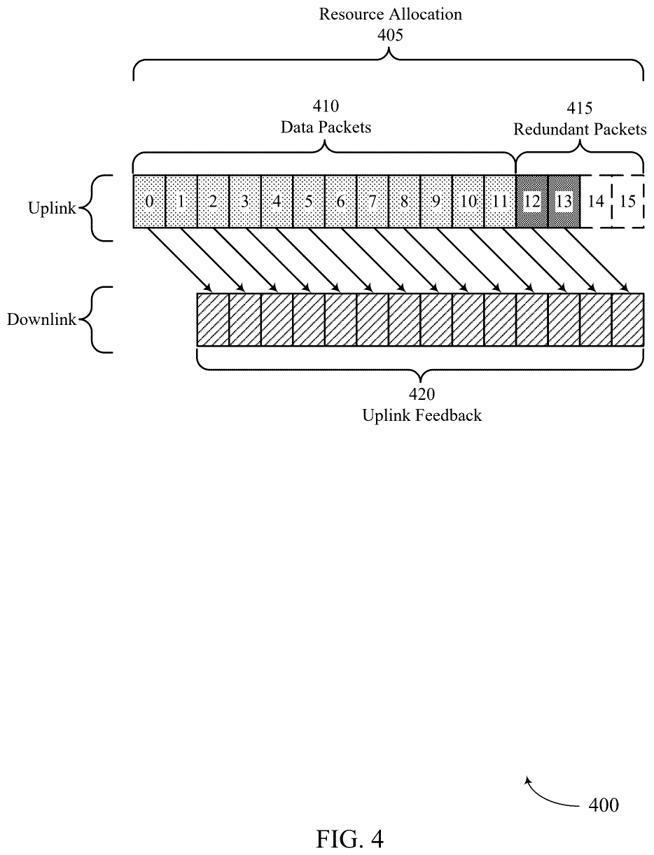

FIG. 4 shows an example of an uplink feedback technique 400 that supports FEC awareness for uplink in accordance with one or more aspects of the present disclosure. The uplink feedback technique 400 may implement some aspects of a wireless communications system 100, a wireless communications system 200, or an uplink feedback technique 300 as described herein. For example, the uplink feedback technique 400 may support uplink feedback for application layer FEC awareness.

A network entity 105 may transmit DCI to grant a resource allocation 405 to a UE 115 for transmission of a set of data packets 410. In some examples, the resource allocation 405 may include resources for the UE 115-a to transmit a set of redundant packets 415 for FEC techniques. For example, if the network entity 105 is unable to decode a data packet, the network entity 105 may use one of the redundant packets to correct decoding errors or repair the data packet.

The network entity 105 may transmit uplink feedback 420 to the UE 115 to indicate HARQ ACK feedback for the set of data packets 410. In the example of the uplink feedback technique 400, the network entity 105 may transmit multiple messages to indicate respective feedback for the set of data packets 410. If the uplink feedback 420 indicates that a sufficient quantity of data packets have been successfully delivered to the network entity 105, the UE 115 may discard remaining packets (e.g., redundant packets) and enter a low power sleep mode.

For example, the resource allocation 405 may include resources for 16 data packets or transport blocks. The UE 115 may receive the uplink feedback 420 and determine, during a transmission time interval for transport block thirteen, that a sufficient quantity of transport blocks have been delivered to the network entity 105 for the network entity 105 to decode the set of data packets 410. The UE 115 may discard remaining transport blocks based on the uplink feedback 420. For example, the UE 115 may discard remaining redundant packets and enter a low power sleep mode instead of transmitting the last two redundant packets.

In some examples, the network entity 105 may transmit DCI with a grant that allocates zero resource blocks for implicit uplink feedback. For example, a DCI message may include a HARQ identifier corresponding to one of the data packets, a new data identifier, and a dummy grant, such as a grant which allocates zero resource blocks. The UE 115 may count the successfully delivered packets or transport blocks based on a quantity of received DCI messages with an NDI and a dummy grant. The UE 115 may memorize a quantity of application layer FEC packets in a transport block and the HARQ identifiers. The UE 115 may check whether the application layer FEC packets are successfully delivered or not from the dummy grants. The UE 115 may count a quantity of successfully delivered application layer FEC packets.

For example, a DCI message providing feedback for a data packet with a HARQ identifier of ‘0’ may indicate a resource block size of ‘0’, an NDI of ‘1’, and a HARQ identifier of ‘0’. Similarly, a DCI message providing feedback for a data packet with a HARQ identifier of ‘1’ may indicate a resource block size of ‘0’, an NDI of ‘1’, and a HARQ identifier of ‘1’. From the dummy grants, the UE 115 may confirm that a sufficient quantity of packets (e.g., twelve packets) have been delivered, so the UE 115 may discard remaining packets (e.g., packets fourteen and fifteen). In some examples, the UE 115 and the network entity 105 may stop a retransmission timer of a corresponding HARQ identifier when a dummy grant that includes the HARQ identifier and has an NDI is communicated from the network entity 105 to the UE 115. For example, the UE 115 may stop a DRX retransmission timer of the corresponding HARQ identifier (e.g., a corresponding HARQ process) based on the dummy grant and enter a low power mode, for example without waiting for the DRX retransmission timer to run and expire.

The network entity 105 may transmit uplink feedback for a data packet when the network entity 105 decodes the data packet. The network entity 105 may not transmit the uplink feedback for a data packet if the network entity 105 has an error decoding the data packet. In some examples, a dummy grant may only be used for indicating an acknowledgment for a certain HARQ identifier and may not be used for scheduling. The DCI may have any DCI format, such as Format 0_0, Format 0_1, or Format 0_2.

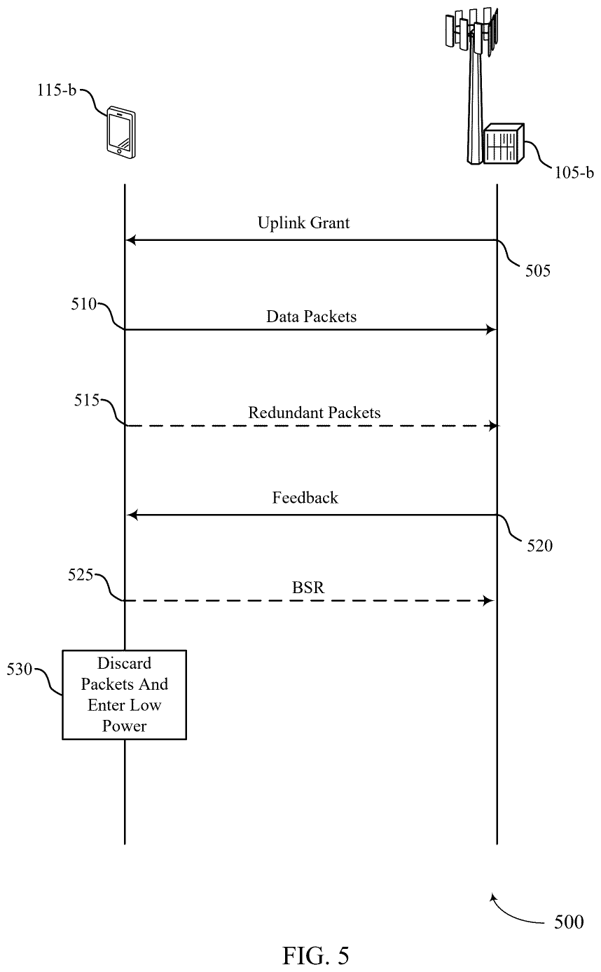

FIG. 5 shows an example of a process flow 500 that supports FEC awareness for uplink in accordance with one or more aspects of the present disclosure. The process flow 500 may implement aspects of a wireless communications system 100, a wireless communications system 200, an uplink feedback technique 300, and an uplink feedback technique 400 described herein. For example, the process flow 500 may be implemented by a UE 115-b and a network entity 105-b, which may be respective examples of a UE 115 and a network entity 105 described herein.

Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 500, some aspects of some operations may also be performed by one or more other wireless devices.

At 505, the UE 115-b may receive an uplink grant for a resource allocation. The resource allocation may be for a set of data packets and a set of redundant packets for FEC. At 510, the UE 115-b may transmit the set of data packets via one or more resources indicated by the resource allocation based on the uplink grant. In some examples, at 515, the UE 115-b may transmit one or more redundant packets of the set of redundant packets via a second one or more resources indicated by the resource allocation based on the uplink grant.

At 520, the UE 115-b may receive an indication that the set of data packets have been successfully delivered in response to transmitting the set of data packets. For example, the network entity 105-b may receive the set of data packets and attempt to decode the set of data packets. In some examples, the network entity 105-b may successfully decode the set of data packets. In some examples, the network entity 105-b may receive the one or more redundant packets and repair one or more of the data packets which were initially unsuccessfully decoded. The network entity 105-b may transmit the indication based on successfully decoding one or more of the data packets or based on successfully decoding all of the data packets.

In some examples, to receive the indication that the set of data packets have been successfully delivered, the UE 115-b may receive DCI having a format associated with DFI. The DCI may indicate that the set of data packets have been successfully delivered. For example, the DCI may include a bitmap that indicates HARQ ACK feedback for each data packet of the set of data packets.

In some examples, to receive the indication that the set of data packets have been successfully delivered, the UE 115-b may receive one or more uplink grants including one or more HARQ identifiers associated with the set of data packets. In some cases, each of the one or more uplink grants may include an NDI. For example, the UE 115-b may receive a first uplink grant in response to a first data packet associated with a first HARQ identifier. The first uplink grant may indicate an NDI, the first HARQ identifier, and a resource block allocation size of zero. For example, the uplink grants may be dummy uplink grants that do not grant resources and are not used for scheduling. In some examples, the UE 115-b may receive an uplink grant responsive to each data packet that is successfully delivered to the network entity 105-b.

In some examples, to receive the indication that the set of data packets have been successfully delivered, the UE 115-b may receive a MAC CE that indicates feedback for the set of data packets. For example, the MAC CE may include a bitmap indicating HARQ feedback for each data packet of the set of data packets. In some examples, to receive the indication that the set of data packets have been successfully delivered, the UE 115-b may receive RLC feedback that indicates feedback for the set of data packets.

In some examples, the UE 115-b may transmit a BSR based on the feedback at 525. For example, the UE 115-b may transmit the BSR to confirm that a sufficient quantity of data packets have been delivered to the network entity 105-b. Transmitting the BSR may prevent the network entity 105-b from allocating additional resources for the UE 115-b to transmit any additional redundant packets, which may be discarded by the UE 115-b.

At 530, the UE 115-b may discard at least a portion of the set of redundant packets based on the indication that the set of data packets have been successfully delivered. For example, the UE 115-b may discard any remaining, non-transmitted redundant packets. In some examples, the UE 115-b may enter a low power mode based on discarding the portion of the set of redundant packets and the indication that the set of data packets have been successfully delivered.

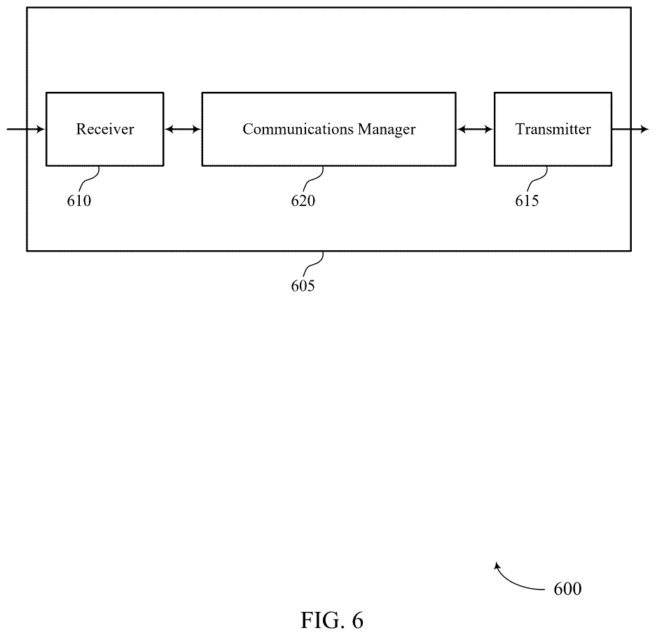

FIG. 6 shows a block diagram 600 of a device 605 that supports FEC awareness for uplink in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to FEC awareness for uplink). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to FEC awareness for uplink). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of FEC awareness for uplink as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving an uplink grant for a resource allocation for a set of multiple data packets and for a set of multiple redundant packets for FEC. The communications manager 620 is capable of, configured to, or operable to support a means for transmitting the set of multiple data packets via one or more resources indicated by the resource allocation based on the uplink grant. The communications manager 620 is capable of, configured to, or operable to support a means for receiving an indication that the set of multiple data packets have been successfully delivered in response to transmitting the set of multiple data packets. The communications manager 620 is capable of, configured to, or operable to support a means for discarding a portion of the set of multiple redundant packets based on the indication that the set of multiple data packets have been successfully delivered.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

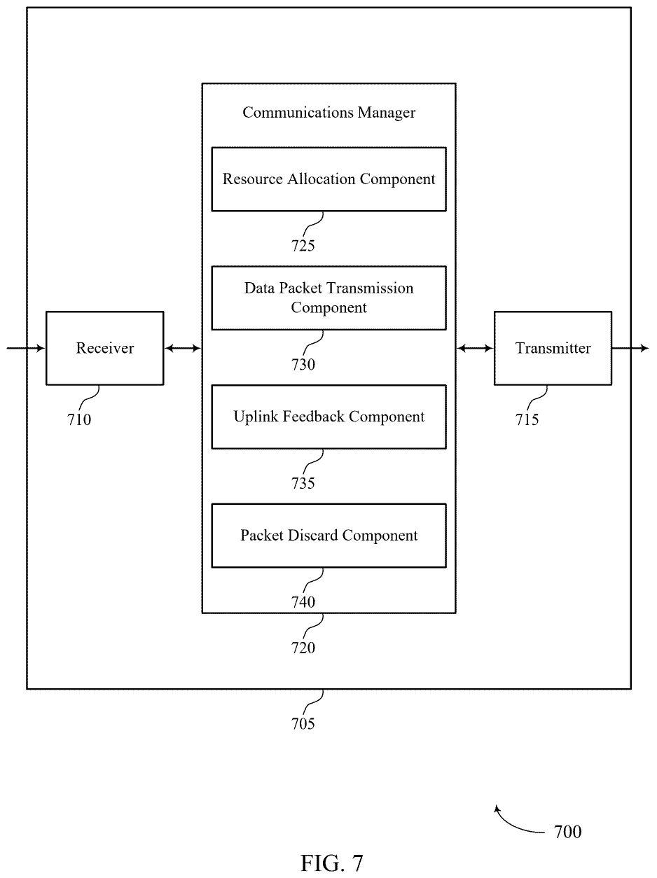

FIG. 7 shows a block diagram 700 of a device 705 that supports FEC awareness for uplink in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to FEC awareness for uplink). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to FEC awareness for uplink). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of FEC awareness for uplink as described herein. For example, the communications manager 720 may include a resource allocation component 725, a data packet transmission component 730, an uplink feedback component 735, a packet discard component 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The resource allocation component 725 is capable of, configured to, or operable to support a means for receiving an uplink grant for a resource allocation for a set of multiple data packets and for a set of multiple redundant packets for FEC. The data packet transmission component 730 is capable of, configured to, or operable to support a means for transmitting the set of multiple data packets via one or more resources indicated by the resource allocation based on the uplink grant. The uplink feedback component 735 is capable of, configured to, or operable to support a means for receiving an indication that the set of multiple data packets have been successfully delivered in response to transmitting the set of multiple data packets. The packet discard component 740 is capable of, configured to, or operable to support a means for discarding a portion of the set of multiple redundant packets based on the indication that the set of multiple data packets have been successfully delivered.

In some cases, the resource allocation component 725, the data packet transmission component 730, the uplink feedback component 735, and the packet discard component 740 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the resource allocation component 725, the data packet transmission component 730, the uplink feedback component 735, and the packet discard component 740 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

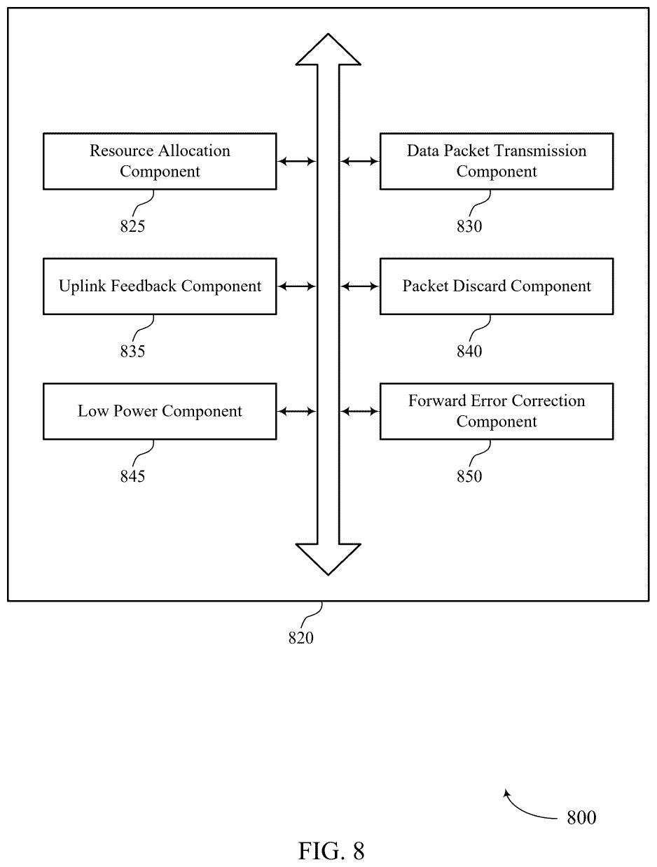

FIG. 8 shows a block diagram 800 of a communications manager 820 that supports FEC awareness for uplink in accordance with one or more aspects of the present disclosure. The communications manager 820 may be an example of aspects of a communications manager 620, a communications manager 720, or both, as described herein. The communications manager 820, or various components thereof, may be an example of means for performing various aspects of FEC awareness for uplink as described herein. For example, the communications manager 820 may include a resource allocation component 825, a data packet transmission component 830, an uplink feedback component 835, a packet discard component 840, a low power component 845, a FEC component 850, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The resource allocation component 825 is capable of, configured to, or operable to support a means for receiving an uplink grant for a resource allocation for a set of multiple data packets and for a set of multiple redundant packets for FEC. The data packet transmission component 830 is capable of, configured to, or operable to support a means for transmitting the set of multiple data packets via one or more resources indicated by the resource allocation based on the uplink grant. The uplink feedback component 835 is capable of, configured to, or operable to support a means for receiving an indication that the set of multiple data packets have been successfully delivered in response to transmitting the set of multiple data packets. The packet discard component 840 is capable of, configured to, or operable to support a means for discarding a portion of the set of multiple redundant packets based on the indication that the set of multiple data packets have been successfully delivered.

In some examples, to support receiving the indication that the set of multiple data packets have been successfully delivered, the uplink feedback component 835 is capable of, configured to, or operable to support a means for receiving DCI having a format associated with downlink feedback information that indicates the set of multiple data packets have been successfully delivered.

In some examples, the DCI includes a bitmap that indicates the set of multiple data packets have been successfully delivered. In some examples, discarding the portion of the set of multiple redundant packets is based on the bitmap.

In some examples, the uplink feedback component 835 is capable of, configured to, or operable to support a means for stopping a retransmission timer in accordance with reception of the DCI.

In some examples, to support receiving the indication that the set of multiple data packets have been successfully delivered, the uplink feedback component 835 is capable of, configured to, or operable to support a means for receiving one or more second uplink grants including one or more hybrid automatic repeat request identifiers associated with the set of multiple data packets and a new data indication.

In some examples, each second uplink grant of the one or more second uplink grants includes an indication that second uplink grant is associated with feedback for the set of multiple data packets and not resource allocation.

In some examples, to support receiving the one or more second uplink grants, the uplink feedback component 835 is capable of, configured to, or operable to support a means for receiving a second uplink grant for each data packet of the set of multiple data packets that has been successfully delivered based on transmitting the set of multiple data packets.

In some examples, the portion of the set of multiple redundant packets are discarded based on a first quantity of the set of multiple data packets being equal to a second quantity of received second uplink grants.

In some examples, to support receiving the indication that the set of multiple data packets have been successfully delivered, the uplink feedback component 835 is capable of, configured to, or operable to support a means for receiving a MAC CE that indicates feedback for the set of multiple data packets.

In some examples, the MAC CE includes a bitmap. In some examples, each bit of the bitmap indicates HARQ feedback for a respective data packet of the set of multiple data packets.

In some examples, to support receiving the indication that the set of multiple data packets have been successfully delivered, the uplink feedback component 835 is capable of, configured to, or operable to support a means for receiving RLC feedback that indicates feedback for the set of multiple data packets.

In some examples, the uplink feedback component 835 is capable of, configured to, or operable to support a means for transmitting a request for the RLC feedback associated with a QoS flow or a data radio bearer associated with the set of multiple data packets.

In some examples, the low power component 845 is capable of, configured to, or operable to support a means for entering a low power mode based on discarding the portion of the set of multiple redundant packets and the indication that the set of multiple data packets have been successfully delivered.

In some examples, the FEC component 850 is capable of, configured to, or operable to support a means for transmitting one or more redundant packets via the one or more resources, where the indication that the set of multiple data packets have been successfully delivered is based on transmission of the one or more redundant packets of the set of multiple redundant packets.

In some cases, the resource allocation component 825, the data packet transmission component 830, the uplink feedback component 835, the packet discard component 840, the low power component 845, the FEC component 850 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the resource allocation component 825, the data packet transmission component 830, the uplink feedback component 835, the packet discard component 840, the low power component 845, the FEC component 850 discussed herein.

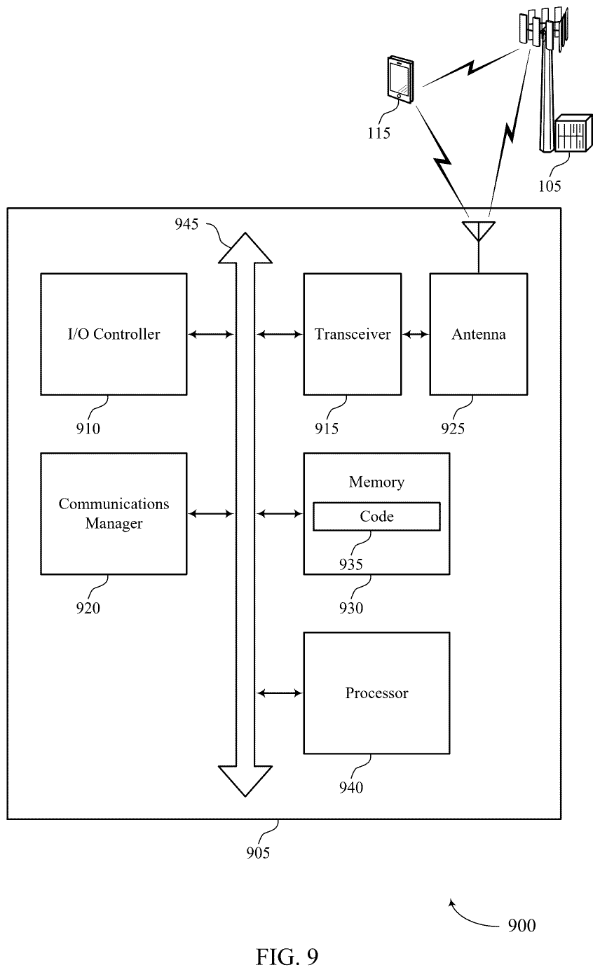

FIG. 9 shows a diagram of a system 900 including a device 905 that supports FEC awareness for uplink in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting FEC awareness for uplink). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving an uplink grant for a resource allocation for a set of multiple data packets and for a set of multiple redundant packets for FEC. The communications manager 920 is capable of, configured to, or operable to support a means for transmitting the set of multiple data packets via one or more resources indicated by the resource allocation based on the uplink grant. The communications manager 920 is capable of, configured to, or operable to support a means for receiving an indication that the set of multiple data packets have been successfully delivered in response to transmitting the set of multiple data packets. The communications manager 920 is capable of, configured to, or operable to support a means for discarding a portion of the set of multiple redundant packets based on the indication that the set of multiple data packets have been successfully delivered.

By including or configuring the communications manager 920 in accordance with examples as described herein, the device 905 may support techniques for reduced latency, reduced power consumption, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of FEC awareness for uplink as described herein, or the at least one processor 940 and the at least one memory 930 may be otherwise configured to, individually or collectively, perform or support such operations.

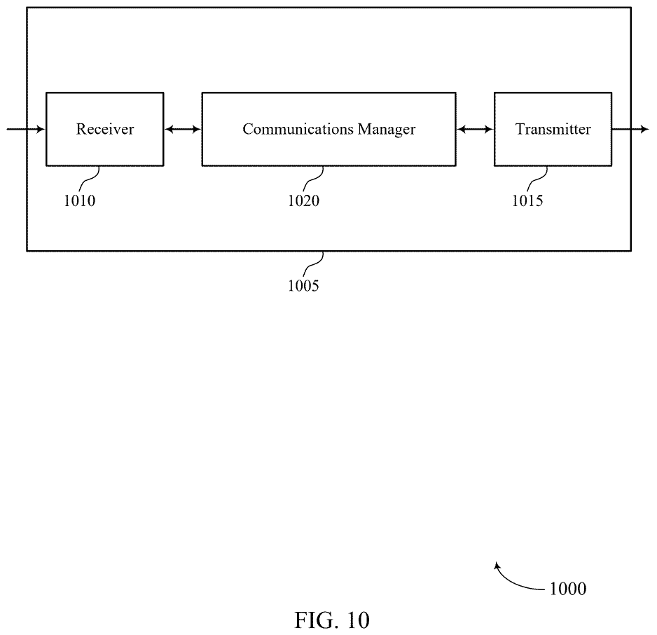

FIG. 10 shows a block diagram 1000 of a device 1005 that supports FEC awareness for uplink in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of FEC awareness for uplink as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting an uplink grant for a resource allocation for a set of multiple data packets and for a set of multiple redundant packets for FEC. The communications manager 1020 is capable of, configured to, or operable to support a means for obtaining the set of multiple data packets via one or more resources indicated by the resource allocation based on the uplink grant. The communications manager 1020 is capable of, configured to, or operable to support a means for outputting an indication that the set of multiple data packets have been successfully delivered based on the set of multiple data packets. The communications manager 1020 is capable of, configured to, or operable to support a means for refraining from monitoring for a portion of the set of multiple redundant packets based on the indication that the set of multiple data packets have been successfully delivered.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, and more efficient utilization of communication resources.

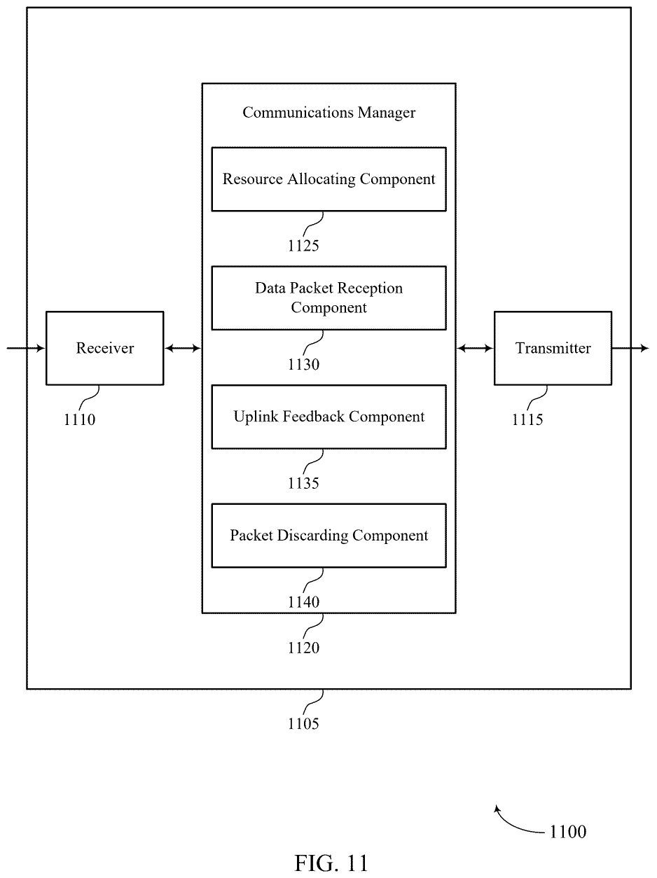

FIG. 11 shows a block diagram 1100 of a device 1105 that supports FEC awareness for uplink in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of FEC awareness for uplink as described herein. For example, the communications manager 1120 may include a resource allocating component 1125, a data packet reception component 1130, an uplink feedback component 1135, a packet discarding component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The resource allocating component 1125 is capable of, configured to, or operable to support a means for outputting an uplink grant for a resource allocation for a set of multiple data packets and for a set of multiple redundant packets for FEC. The data packet reception component 1130 is capable of, configured to, or operable to support a means for obtaining the set of multiple data packets via one or more resources indicated by the resource allocation based on the uplink grant. The uplink feedback component 1135 is capable of, configured to, or operable to support a means for outputting an indication that the set of multiple data packets have been successfully delivered based on the set of multiple data packets. The packet discarding component 1140 is capable of, configured to, or operable to support a means for refraining from monitoring for a portion of the set of multiple redundant packets based on the indication that the set of multiple data packets have been successfully delivered.

In some cases, the resource allocating component 1125, the data packet reception component 1130, the uplink feedback component 1135, and the packet discarding component 1140 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the resource allocating component 1125, the data packet reception component 1130, the uplink feedback component 1135, and the packet discarding component 1140 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

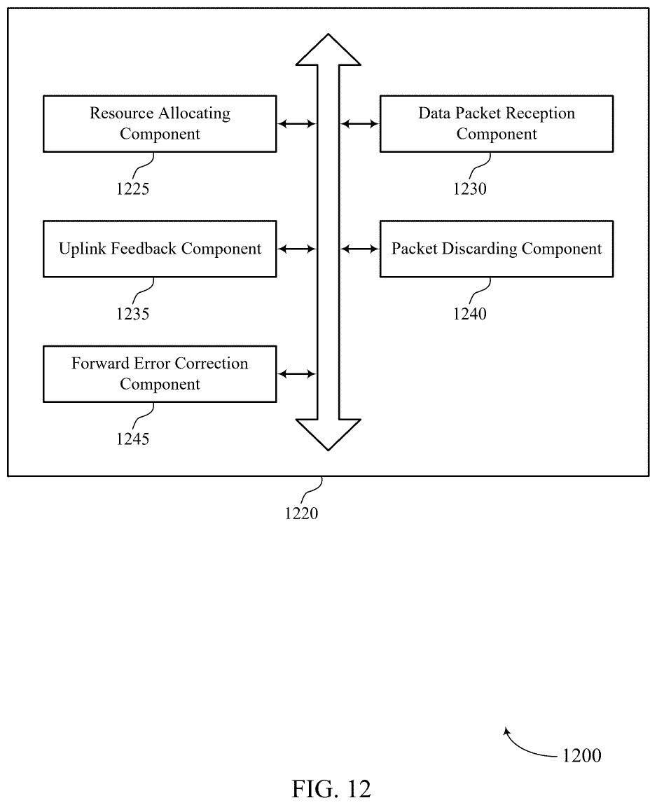

FIG. 12 shows a block diagram 1200 of a communications manager 1220 that supports FEC awareness for uplink in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of FEC awareness for uplink as described herein. For example, the communications manager 1220 may include a resource allocating component 1225, a data packet reception component 1230, an uplink feedback component 1235, a packet discarding component 1240, a FEC component 1245, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The resource allocating component 1225 is capable of, configured to, or operable to support a means for outputting an uplink grant for a resource allocation for a set of multiple data packets and for a set of multiple redundant packets for FEC. The data packet reception component 1230 is capable of, configured to, or operable to support a means for obtaining the set of multiple data packets via one or more resources indicated by the resource allocation based on the uplink grant. The uplink feedback component 1235 is capable of, configured to, or operable to support a means for outputting an indication that the set of multiple data packets have been successfully delivered based on the set of multiple data packets. The packet discarding component 1240 is capable of, configured to, or operable to support a means for refraining from monitoring for a portion of the set of multiple redundant packets based on the indication that the set of multiple data packets have been successfully delivered.

In some examples, the FEC component 1245 is capable of, configured to, or operable to support a means for unsuccessfully decoding at least a first data packet of the set of multiple data packets. In some examples, the FEC component 1245 is capable of, configured to, or operable to support a means for obtaining at least one redundant packets of the set of multiple redundant packets via the resource allocation. In some examples, the FEC component 1245 is capable of, configured to, or operable to support a means for repairing at least the first data packet based on the at least one redundant packets, where the indication that the set of multiple data packets have been successfully delivered is transmitted based on repairing at least the first data packet.

In some examples, to support outputting the indication that the set of multiple data packets have been successfully delivered, the uplink feedback component 1235 is capable of, configured to, or operable to support a means for outputting DCI having a format associated with downlink feedback information that indicates the set of multiple data packets have been successfully delivered.

In some examples, the DCI includes a bitmap that indicates the set of multiple data packets have been successfully delivered. In some examples, discarding the portion of the set of multiple redundant packets is based on the bitmap.

In some examples, to support outputting the indication that the set of multiple data packets have been successfully delivered, the uplink feedback component 1235 is capable of, configured to, or operable to support a means for outputting one or more second uplink grants including one or more hybrid automatic repeat request identifiers associated with the set of multiple data packets and a new data indication.

In some examples, each second uplink grant of the one or more second uplink grants includes an indication that the second uplink grant is associated with feedback for the set of multiple data packets and not resource allocation.

In some examples, to support outputting the one or more second uplink grants, the uplink feedback component 1235 is capable of, configured to, or operable to support a means for outputting a second uplink grant for each data packet of the set of multiple data packets that has been successfully delivered based on a successful decoding of the set of multiple data packets.

In some examples, a first quantity of the set of multiple data packets is equal to a second quantity of transmitted second uplink grants indicating an acknowledgment.

In some examples, to support outputting the indication that the set of multiple data packets have been successfully delivered, the uplink feedback component 1235 is capable of, configured to, or operable to support a means for outputting a MAC CE that indicates feedback for the set of multiple data packets.

In some examples, the MAC CE includes a bitmap. In some examples, each bit of the bitmap indicates HARQ feedback for a respective data packet of the set of multiple data packets.

In some examples, to support outputting the indication that the set of multiple data packets have been successfully delivered, the uplink feedback component 1235 is capable of, configured to, or operable to support a means for outputting RLC feedback that indicates feedback for the set of multiple data packets.

In some examples, the uplink feedback component 1235 is capable of, configured to, or operable to support a means for obtaining a request for the RLC feedback associated with a QoS flow or a data radio bearer associated with the set of multiple data packets, where outputting the RLC feedback is based on the request.

In some examples, the FEC component 1245 is capable of, configured to, or operable to support a means for obtaining one or more redundant packets via the resource allocation, where the indication that the set of multiple data packets have been successfully delivered is based on the one or more redundant packets of the set of multiple redundant packets.

In some cases, the resource allocating component 1225, the data packet reception component 1230, the uplink feedback component 1235, the packet discarding component 1240, the FEC component 1245 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the resource allocating component 1225, the data packet reception component 1230, the uplink feedback component 1235, the packet discarding component 1240, the FEC component 1245 discussed herein.

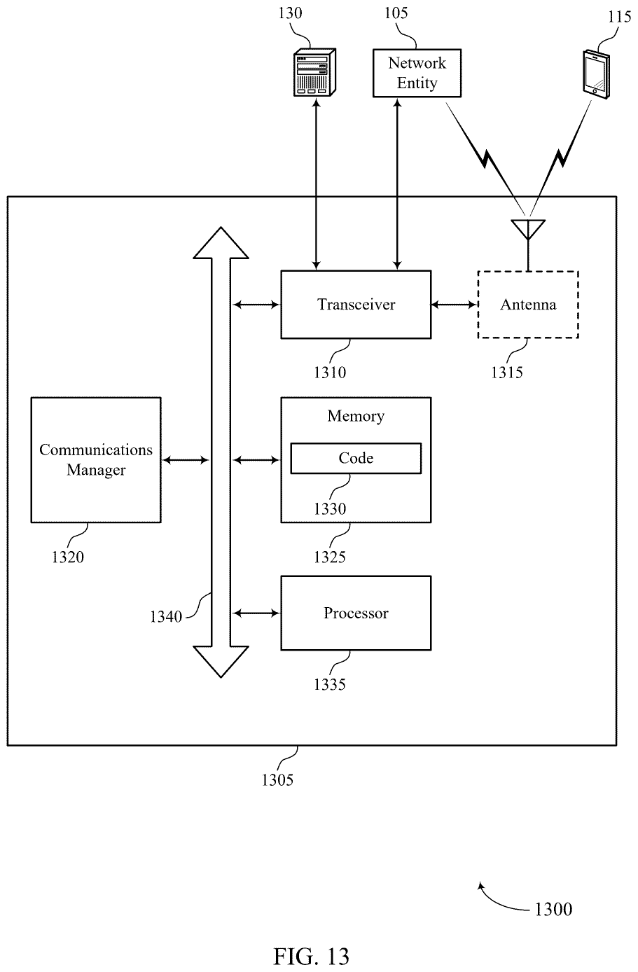

FIG. 13 shows a diagram of a system 1300 including a device 1305 that supports FEC awareness for uplink in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting FEC awareness for uplink). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting an uplink grant for a resource allocation for a set of multiple data packets and for a set of multiple redundant packets for FEC. The communications manager 1320 is capable of, configured to, or operable to support a means for obtaining the set of multiple data packets via one or more resources indicated by the resource allocation based on the uplink grant. The communications manager 1320 is capable of, configured to, or operable to support a means for outputting an indication that the set of multiple data packets have been successfully delivered based on the set of multiple data packets. The communications manager 1320 is capable of, configured to, or operable to support a means for refraining from monitoring for a portion of the set of multiple redundant packets based on the indication that the set of multiple data packets have been successfully delivered.

By including or configuring the communications manager 1320 in accordance with examples as described herein, the device 1305 may support techniques for reduced latency, reduced power consumption, and more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of FEC awareness for uplink as described herein, or the at least one processor 1335 and the at least one memory 1325 may be otherwise configured to, individually or collectively, perform or support such operations.

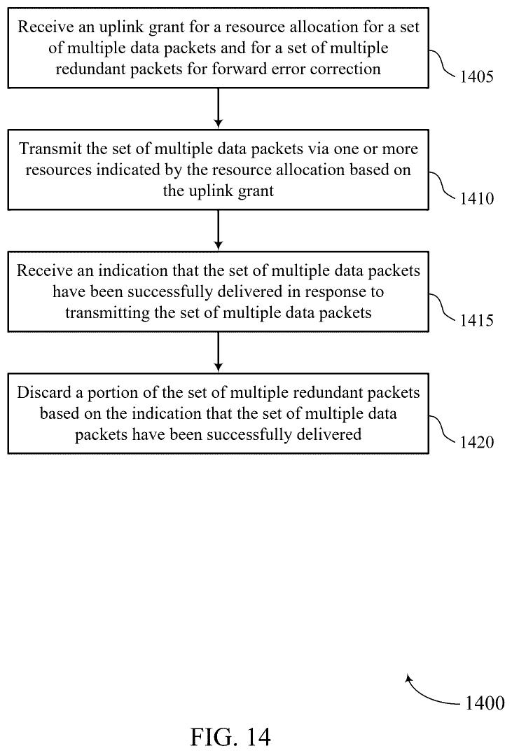

FIG. 14 shows a flowchart illustrating a method 1400 that supports FEC awareness for uplink in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving an uplink grant for a resource allocation for a set of multiple data packets and for a set of multiple redundant packets for FEC. The operations of 1405 may be performed in accordance with examples as disclosed herein. In some examples, aspects of the operations of 1405 may be performed by a resource allocation component 825 as described with reference to FIG. 8.

At 1410, the method may include transmitting the set of multiple data packets via one or more resources indicated by the resource allocation based on the uplink grant. The operations of 1410 may be performed in accordance with examples as disclosed herein. In some examples, aspects of the operations of 1410 may be performed by a data packet transmission component 830 as described with reference to FIG. 8.

At 1415, the method may include receiving an indication that the set of multiple data packets have been successfully delivered in response to transmitting the set of multiple data packets. The operations of 1415 may be performed in accordance with examples as disclosed herein. In some examples, aspects of the operations of 1415 may be performed by an uplink feedback component 835 as described with reference to FIG. 8.

At 1420, the method may include discarding a portion of the set of multiple redundant packets based on the indication that the set of multiple data packets have been successfully delivered. The operations of 1420 may be performed in accordance with examples as disclosed herein. In some examples, aspects of the operations of 1420 may be performed by a packet discard component 840 as described with reference to FIG. 8.

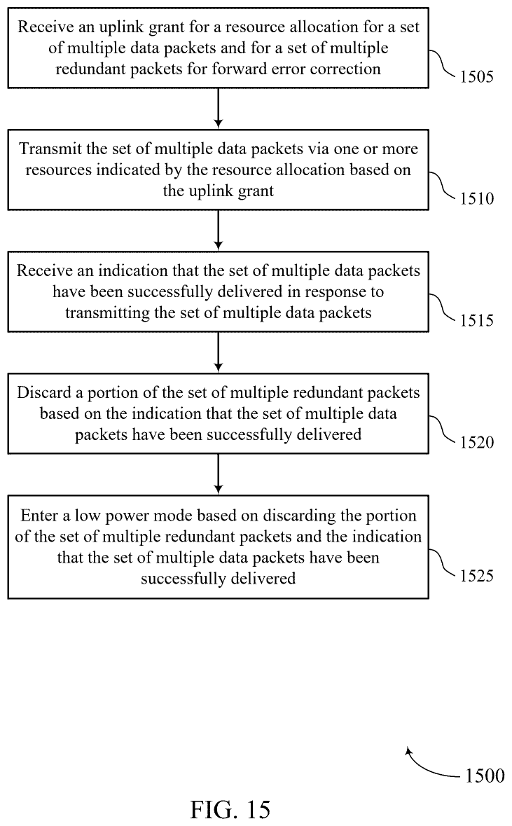

FIG. 15 shows a flowchart illustrating a method 1500 that supports FEC awareness for uplink in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving an uplink grant for a resource allocation for a set of multiple data packets and for a set of multiple redundant packets for FEC. The operations of 1505 may be performed in accordance with examples as disclosed herein. In some examples, aspects of the operations of 1505 may be performed by a resource allocation component 825 as described with reference to FIG. 8.

At 1510, the method may include transmitting the set of multiple data packets via one or more resources indicated by the resource allocation based on the uplink grant. The operations of 1510 may be performed in accordance with examples as disclosed herein. In some examples, aspects of the operations of 1510 may be performed by a data packet transmission component 830 as described with reference to FIG. 8.

At 1515, the method may include receiving an indication that the set of multiple data packets have been successfully delivered in response to transmitting the set of multiple data packets. The operations of 1515 may be performed in accordance with examples as disclosed herein. In some examples, aspects of the operations of 1515 may be performed by an uplink feedback component 835 as described with reference to FIG. 8.

At 1520, the method may include discarding a portion of the set of multiple redundant packets based on the indication that the set of multiple data packets have been successfully delivered. The operations of 1520 may be performed in accordance with examples as disclosed herein. In some examples, aspects of the operations of 1520 may be performed by a packet discard component 840 as described with reference to FIG. 8.

At 1525, the method may include entering a low power mode based on discarding the portion of the set of multiple redundant packets and the indication that the set of multiple data packets have been successfully delivered. The operations of 1525 may be performed in accordance with examples as disclosed herein. In some examples, aspects of the operations of 1525 may be performed by a low power component 845 as described with reference to FIG. 8.

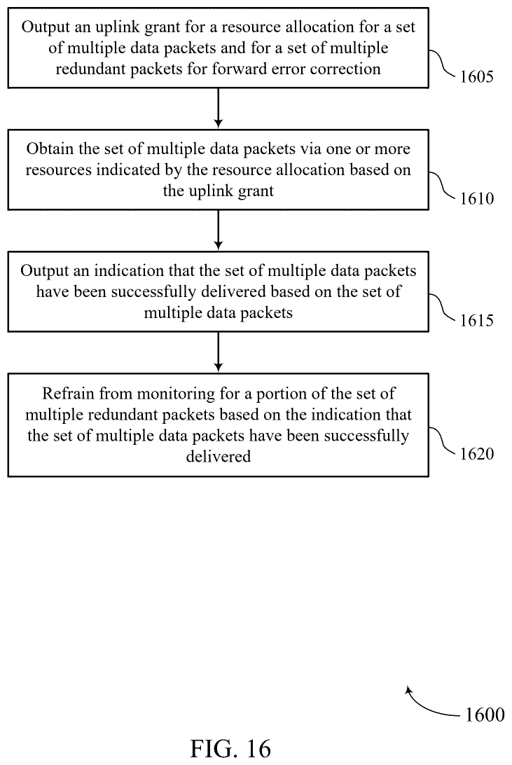

FIG. 16 shows a flowchart illustrating a method 1600 that supports FEC awareness for uplink in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include outputting an uplink grant for a resource allocation for a set of multiple data packets and for a set of multiple redundant packets for FEC. The operations of 1605 may be performed in accordance with examples as disclosed herein. In some examples, aspects of the operations of 1605 may be performed by a resource allocating component 1225 as described with reference to FIG. 12.

At 1610, the method may include obtaining the set of multiple data packets via one or more resources indicated by the resource allocation based on the uplink grant. The operations of 1610 may be performed in accordance with examples as disclosed herein. In some examples, aspects of the operations of 1610 may be performed by a data packet reception component 1230 as described with reference to FIG. 12.

At 1615, the method may include outputting an indication that the set of multiple data packets have been successfully delivered based on the set of multiple data packets. The operations of 1615 may be performed in accordance with examples as disclosed herein. In some examples, aspects of the operations of 1615 may be performed by an uplink feedback component 1235 as described with reference to FIG. 12.

At 1620, the method may include refraining from monitoring for a portion of the set of multiple redundant packets based on the indication that the set of multiple data packets have been successfully delivered. The operations of 1620 may be performed in accordance with examples as disclosed herein. In some examples, aspects of the operations of 1620 may be performed by a packet discarding component 1240 as described with reference to FIG. 12.

The following provides an overview of aspects of the present disclosure:
Aspect 1: A method for wireless communications at a UE, comprising: receiving an uplink grant for a resource allocation for a plurality of data packets and for a plurality of redundant packets for forward error correction; transmitting the plurality of data packets via one or more resources indicated by the resource allocation based at least in part on the uplink grant; receiving an indication that the plurality of data packets have been successfully delivered in response to transmitting the plurality of data packets; and discarding a portion of the plurality of redundant packets based at least in part on the indication that the plurality of data packets have been successfully delivered.
Aspect 2: The method of aspect 1, wherein receiving the indication that the plurality of data packets have been successfully delivered comprises: receiving DCI having a format associated with downlink feedback information that indicates the plurality of data packets have been successfully delivered.
Aspect 3: The method of aspect 2, wherein the DCI comprises a bitmap that indicates the plurality of data packets have been successfully delivered, discarding the portion of the plurality of redundant packets is based at least in part on the bitmap.
Aspect 4: The method of any of aspects 1 through 3, wherein receiving the indication that the plurality of data packets have been successfully delivered comprises: receiving one or more second uplink grants comprising one or more hybrid automatic repeat request identifiers associated with the plurality of data packets and a new data indication.
Aspect 5: The method of aspect 4, wherein each second uplink grant of the one or more second uplink grants comprises an indication that second uplink grant is associated with feedback for the plurality of data packets and not resource allocation.
Aspect 6: The method of any of aspects 4 through 5, wherein receiving the one or more second uplink grants comprises: receiving a second uplink grant for each data packet of the plurality of data packets that has been successfully delivered based at least in part on transmitting the plurality of data packets.
Aspect 7: The method of aspect 6, wherein the portion of the plurality of redundant packets are discarded based at least in part on a first quantity of the plurality of data packets being equal to a second quantity of received second uplink grants.
Aspect 8: The method of any of aspects 1 through 7, wherein receiving the indication that the plurality of data packets have been successfully delivered comprises: receiving a medium access control (MAC) control element (CE) that indicates feedback for the plurality of data packets.
Aspect 9: The method of aspect 8, wherein the MAC CE comprises a bitmap; and each bit of the bitmap indicates HARQ feedback for a respective data packet of the plurality of data packets.
Aspect 10: The method of any of aspects 1 through 9, wherein receiving the indication that the plurality of data packets have been successfully delivered comprises: receiving RLC feedback that indicates feedback for the plurality of data packets.
Aspect 11: The method of aspect 10, further comprising: transmitting a request for the RLC feedback associated with a Quality of Service (QoS) flow or a data radio bearer associated with the plurality of data packets.
Aspect 12: The method of any of aspects 1 through 11, further comprising: entering a low power mode based at least in part on discarding the portion of the plurality of redundant packets and the indication that the plurality of data packets have been successfully delivered.
Aspect 13: The method of any of aspects 1 through 12, further comprising: transmitting one or more redundant packets via the one or more resources, wherein the indication that the plurality of data packets have been successfully delivered is based at least in part on transmission of the one or more redundant packets of the plurality of redundant packets.
Aspect 14: A method for wireless communications at a network entity, comprising: outputting an uplink grant for a resource allocation for a plurality of data packets and for a plurality of redundant packets for forward error correction; obtaining the plurality of data packets via one or more resources indicated by the resource allocation based at least in part on the uplink grant; outputting an indication that the plurality of data packets have been successfully delivered based at least in part on the plurality of data packets; and refraining from monitoring for a portion of the plurality of redundant packets based at least in part on the indication that the plurality of data packets have been successfully delivered.
Aspect 15: The method of aspect 14, further comprising: unsuccessfully decoding at least a first data packet of the plurality of data packets; obtaining at least one redundant packets of the plurality of redundant packets via the resource allocation; and repairing at least the first data packet based at least in part on the at least one redundant packets, wherein the indication that the plurality of data packets have been successfully delivered is transmitted based at least in part on repairing at least the first data packet.
Aspect 16: The method of any of aspects 14 through 15, wherein outputting the indication that the plurality of data packets have been successfully delivered comprises: outputting DCI having a format associated with downlink feedback information that indicates the plurality of data packets have been successfully delivered.
Aspect 17: The method of aspect 16, wherein the DCI comprises a bitmap that indicates the plurality of data packets have been successfully delivered, discarding the portion of the plurality of redundant packets is based at least in part on the bitmap.
Aspect 18: The method of aspect 16, further comprising: stopping a retransmission timer in accordance with reception of the DCI.
Aspect 19: The method of any of aspects 14 through 17, wherein outputting the indication that the plurality of data packets have been successfully delivered comprises: outputting one or more second uplink grants comprising one or more hybrid automatic repeat request identifiers associated with the plurality of data packets and a new data indication.
Aspect 20: The method of aspect 19, wherein each second uplink grant of the one or more second uplink grants comprises an indication that the second uplink grant is associated with feedback for the plurality of data packets and not resource allocation.
Aspect 21: The method of any of aspects 19 through 20, wherein outputting the one or more second uplink grants comprises: outputting a second uplink grant for each data packet of the plurality of data packets that has been successfully delivered based at least in part on a successful decoding of the plurality of data packets.
Aspect 22: The method of aspect 21, wherein a first quantity of the plurality of data packets is equal to a second quantity of transmitted second uplink grants indicating an acknowledgment.
Aspect 23: The method of any of aspects 14 through 22, wherein outputting the indication that the plurality of data packets have been successfully delivered comprises: outputting a medium access control (MAC) control element (CE) that indicates feedback for the plurality of data packets.
Aspect 24: The method of aspect 23, wherein the MAC CE comprises a bitmap; and each bit of the bitmap indicates HARQ feedback for a respective data packet of the plurality of data packets.
Aspect 25: The method of any of aspects 14 through 24, wherein outputting the indication that the plurality of data packets have been successfully delivered comprises: outputting RLC feedback that indicates feedback for the plurality of data packets.
Aspect 26: The method of aspect 25, further comprising: obtaining a request for the RLC feedback associated with a Quality of Service (QoS) flow or a data radio bearer associated with the plurality of data packets, wherein outputting the RLC feedback is based at least in part on the request.
Aspect 27: The method of any of aspects 14 through 26, further comprising: obtaining one or more redundant packets via the resource allocation, wherein the indication that the plurality of data packets have been successfully delivered is based at least in part on the one or more redundant packets of the plurality of redundant packets.
Aspect 28: A UE for wireless communications, comprising one or more memories storing processor-executable code, and one or more processors coupled with the one or more memories and individually or collectively operable to execute the code to cause the UE to perform a method of any of aspects 1 through 13.
Aspect 29: A UE for wireless communications, comprising at least one means for performing a method of any of aspects 1 through 13.
Aspect 30: A non-transitory computer-readable medium storing code for wireless communications, the code comprising instructions executable by one or more processors to perform a method of any of aspects 1 through 13.
Aspect 31: A network entity for wireless communications, comprising one or more memories storing processor-executable code, and one or more processors coupled with the one or more memories and individually or collectively operable to execute the code to cause the network entity to perform a method of any of aspects 14 through 27.
Aspect 32: A network entity for wireless communications, comprising at least one means for performing a method of any of aspects 14 through 27.
Aspect 33: A non-transitory computer-readable medium storing code for wireless communications, the code comprising instructions executable by one or more processors to perform a method of any of aspects 14 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an uplink grant for a resource allocation for a plurality of data packets and for a plurality of redundant packets for forward error correction;
transmit the plurality of data packets via one or more resources indicated by the resource allocation based at least in part on the uplink grant;
receive an indication that the plurality of data packets have been successfully delivered in response to transmitting the plurality of data packets; and
discard a portion of the plurality of redundant packets based at least in part on the indication that the plurality of data packets have been successfully delivered.

2. The UE of claim 1, wherein, to receive the indication that the plurality of data packets have been successfully delivered, the one or more processors are individually or collectively operable to execute the code to cause the UE to:
receive downlink control information having a format associated with downlink feedback information that indicates the plurality of data packets have been successfully delivered.

3. The UE of claim 2, wherein:
the downlink control information comprises a bitmap that indicates the plurality of data packets have been successfully delivered; and
discarding the portion of the plurality of redundant packets is based at least in part on the bitmap.

4. The UE of claim 2, further comprising:
stopping a retransmission timer in accordance with reception of the downlink control information.

5. The UE of claim 1, wherein, to receive the indication that the plurality of data packets have been successfully delivered, the one or more processors are individually or collectively operable to execute the code to cause the UE to:
receive one or more second uplink grants comprising one or more hybrid automatic repeat request identifiers associated with the plurality of data packets and a new data indication.

6. The UE of claim 5, wherein each second uplink grant of the one or more second uplink grants comprises an indication that second uplink grant is associated with feedback for the plurality of data packets and not resource allocation.

7. The UE of claim 5, wherein, to receive the one or more second uplink grants, the one or more processors are individually or collectively operable to execute the code to cause the UE to:
receive a second uplink grant for each data packet of the plurality of data packets that has been successfully delivered based at least in part on transmitting the plurality of data packets.

8. The UE of claim 7, wherein the portion of the plurality of redundant packets are discarded based at least in part on a first quantity of the plurality of data packets being equal to a second quantity of received second uplink grants.

9. The UE of claim 1, wherein, to receive the indication that the plurality of data packets have been successfully delivered, the one or more processors are individually or collectively operable to execute the code to cause the UE to:
receive a medium access control (MAC) control element (CE) that indicates feedback for the plurality of data packets.

10. The UE of claim 9, wherein:
the MAC CE comprises a bitmap; and
each bit of the bitmap indicates hybrid automatic repeat request (HARQ) feedback for a respective data packet of the plurality of data packets.

11. The UE of claim 1, wherein, to receive the indication that the plurality of data packets have been successfully delivered, the one or more processors are individually or collectively operable to execute the code to cause the UE to:
receive radio link control (RLC) feedback that indicates feedback for the plurality of data packets.

12. The UE of claim 11, wherein the one or more processors are individually or collectively further operable to execute the code to cause the UE to:
transmit a request for the RLC feedback associated with a Quality of Service (QoS) flow or a data radio bearer associated with the plurality of data packets.

13. The UE of claim 1, wherein the one or more processors are individually or collectively further operable to execute the code to cause the UE to:
enter a low power mode based at least in part on discarding the portion of the plurality of redundant packets and the indication that the plurality of data packets have been successfully delivered.

14. The UE of claim 1, wherein the one or more processors are individually or collectively further operable to execute the code to cause the UE to:
transmit one or more redundant packets via the one or more resources, wherein the indication that the plurality of data packets have been successfully delivered is based at least in part on transmission of the one or more redundant packets of the plurality of redundant packets.

15. A network entity, comprising:
one or more memories storing processor-executable code; and
one or more processors coupled with the one or more memories and individually or collectively operable to execute the code to cause the network entity to:
output an uplink grant for a resource allocation for a plurality of data packets and for a plurality of redundant packets for forward error correction;
obtain the plurality of data packets via one or more resources indicated by the resource allocation based at least in part on the uplink grant;
output an indication that the plurality of data packets have been successfully delivered based at least in part on the plurality of data packets; and
refrain from monitoring for a portion of the plurality of redundant packets based at least in part on the indication that the plurality of data packets have been successfully delivered.

16. The network entity of claim 15, wherein the one or more processors are individually or collectively further operable to execute the code to cause the network entity to:
unsuccessfully decode at least a first data packet of the plurality of data packets;
obtain at least one redundant packets of the plurality of redundant packets via the resource allocation; and
repair at least the first data packet based at least in part on the at least one redundant packets, wherein the indication that the plurality of data packets have been successfully delivered is transmitted based at least in part on repairing at least the first data packet.

17. The network entity of claim 15, wherein, to output the indication that the plurality of data packets have been successfully delivered, the one or more processors are individually or collectively operable to execute the code to cause the network entity to:
output downlink control information having a format associated with downlink feedback information that indicates the plurality of data packets have been successfully delivered.

18. The network entity of claim 15, wherein, to output the indication that the plurality of data packets have been successfully delivered, the one or more processors are individually or collectively operable to execute the code to cause the network entity to:
output one or more second uplink grants comprising one or more hybrid automatic repeat request identifiers associated with the plurality of data packets and a new data indication.

19. The network entity of claim 18, wherein, to output the one or more second uplink grants, the one or more processors are individually or collectively operable to execute the code to cause the network entity to:
output a second uplink grant for each data packet of the plurality of data packets that has been successfully delivered based at least in part on a successful decoding of the plurality of data packets.

20. A method for wireless communications at a user equipment (UE), comprising:
receiving an uplink grant for a resource allocation for a plurality of data packets and for a plurality of redundant packets for forward error correction;
transmitting the plurality of data packets via one or more resources indicated by the resource allocation based at least in part on the uplink grant;
receiving an indication that the plurality of data packets have been successfully delivered in response to transmitting the plurality of data packets; and
discarding a portion of the plurality of redundant packets based at least in part on the indication that the plurality of data packets have been successfully delivered.
